(19) United States
(12) Patent Application Publication
(10) Pub. No.: US 2024/0162676 A1
(43) Pub. Date: May 16, 2024

(54) GAIN SWITCH SPIKE SUPPRESSION THROUGH TEMPORAL AND/OR AMPLITUDE MANIPULATION OF THE PUMP ENERGY

(71) Applicant: nLIGHT, Inc., Camas, WA (US)

(72) Inventors: Tyson L. LOWDER, Vancouver, WA (US); Robert Joseph FOLEY, Portland, OR (US)

(21) Appl. No.: 18/510,073

(22) Filed: Nov. 15, 2023

Related U.S. Application Data
(60) Provisional application No. 63/425,851, filed on Nov. 16, 2022.

(51) Int. Cl. H01S 3/0941; H01S 3/094; H01S 3/131

(52) U.S. Cl. CPC H01S 3/09415; H01S 3/094076; H01S 3/1315

(57) ABSTRACT

A laser system may include a gain medium; and pump modules to energize the gain medium or a single pump emitter to energize the gain medium; and circuitry to: configure a pump emitter of the pump modules to activate at a first intensity at a first time, or configure a pump emitter of the single pump module to activate at a reduced intensity at the first time; and the circuitry to: configure one or more next pumps emitters of the pump modules to activate at one or more second intensities, respectively, and at one or more second times, respectively, or configure the single pump emitter to activate at one or more second intensities at the one or more second times, respectively, wherein the one or more second times are delayed by one or more delay amounts, respectively, relative to the first time.

CROSS-REFERENCE TO RELATED APPLICATION(S)

This application relies for priority on U.S. Provisional Patent Application Ser. No. 63/425,851, entitled “GAIN SWITCH SPIKE SUPPRESSION THROUGH TEMPORAL AND/OR AMPLITUDE MANIPULATION OF THE PUMP ENERGY,” filed Nov. 16, 2022, the content of which is hereby incorporated by reference in its entirety.

### FIELD OF THE INVENTION

The present disclosure relates to laser systems.

### BACKGROUND OF THE INVENTION

When a laser system is “turned-on” (meaning pump energy is supplied to the gain medium), a short, intense laser pulse is often emitted before the laser settles to some steady-state value. This short, intense pulse is known as the gain switch spike and is the result of the pump energy being quickly delivered to the gain medium. Because the laser was “off” prior to the supply of pump energy, the buildup of laser energy in the gain medium is amplified beyond the usual steady-state value as pump energy is stored in the gain medium for a short amount of time prior to the population inversion exceeding the laser threshold. Once this threshold is exceeded, the overamplified energy is extracted as a short intense laser pulse. If the pump energy continues to be supplied at a constant rate, the laser will settle into a steady state condition.

### BRIEF DESCRIPTION OF THE DRAWINGS

The accompanying drawings, wherein like reference numerals represent like elements, are incorporated in and constitute a part of this specification and, together with the description, explain the advantages and principles of the presently disclosed technology.

FIGS. 1A and 1B illustrate schematic diagrams of a laser system arranged for gain switch spike suppression, according to various embodiments.

FIG. 2A illustrates an oscilloscope trace showing an improved gain switch spike corresponding to temporally delayed turn-ons of pumps of a three-pump laser system similar in any respect to the laser system of FIGS. 1A and 1B.

FIG. 2B illustrates an oscilloscope trace showing an optical pulse after the gain switch spike of FIG. 2A.

FIG. 3 illustrates an optical spectrum analyzer time averaged trace plotting the reduced Simulated Raman Scattering (SRS) generated non-linear light when using the temporally delayed turn-ons of pumps of the three-pump laser system having the oscilloscope trace of FIG. 2A.

FIG. 4 illustrates another oscilloscope trace showing another improved gain switch spike corresponding to temporally delayed initiations of pump emitters in combination with amplitude manipulation.

FIG. 5 illustrates a schematic diagram of a laser system arranged for gain switch spike suppression in which amplitude manipulation is used with a single pump module, according to various embodiments.

FIG. 6 is a flowchart illustrating operations performed by a pump controller arranged for gain switch spike suppression through temporal and/or amplitude manipulation of the pump energy, according to various embodiments.

FIG. 7A illustrates an oscilloscope trace for a known “turn on” of a laser system showing that the peak power of the gain switch spike can be several times greater than eventual steady state power level of the laser.

FIG. 7B illustrates an optical spectrum analyzer time averaged trace plotting the typical Simulated Raman Scattering (SRS) corresponding to a known three-pump laser system in which all three pumps are turned on at the same time with the same intensity and synchronously modulated.

FIG. 7C illustrates an oscilloscope trace showing laser instability after the gain switch spike produced in the three pump module system in which all three pumps are turned on at the same time with the same intensity and synchronously modulated as shown in FIG. 7B.

### DETAILED DESCRIPTION OF EMBODIMENT(S) OF THE INVENTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatuses.

Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatuses are referred to as “lowest,” “best,” “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

In some applications, the gain switch spike can be desirable and is one method to creating short pulsed laser operation. However, in many applications (including applications that require a continuous wave laser beam, or applications that require a pulsed beam) the gain switch may be undesirable due to the very high peak power that it creates (in some known laser systems, the gain switch spike may emit with at least 2.5× the peak power of the steady state level, for example). This high peak power can be a reliability risk to internal components of the laser or to external components of an application setup that are not rated to handle such high peak powers.

The high peak power of the gain switch spike may also drive non-linear laser processes such as Stimulated Raman Scattering (SRS). SRS is a non-linear process where energy from the main laser signal wavelength is transferred to other wavelengths. Again, this situation could create reliability risks to both internal and external components of an application setup. In addition to the reliability risk, the different wavelengths of light might interact with any optical setup differently than intended (for example this light might focus differently than the main signal light) and create unintended results. Lastly, the SRS light that is generated due to the high peak power of the gain switch spike, can also lead to laser instabilities that again might create unintended application results.

To overcome the reliability risks and the unintended application results, it may be desirable to optimize the gain switch spike of the laser system. In various embodiments, a controller may be provided to slow down the delivery of the pump energy to the gain medium such that excess energy is not stored in the gain medium causing over amplification once the lasing threshold is exceeded.

In many laser systems, the pump energy is supplied by more than one pump emitter (each of which may include a set of one or more laser diodes). In these instances, the pump energy of one pump emitter can be temporally delayed relative to the other pump emitter(s) as to not over energize the gain medium prior to the lasing threshold. This may be performed by using a controller to control drivers for the pump emitters, to cause the pump emitters to turn on at different times (e.g., sequentially). By temporally staging the pump emitters, the gain switch spike may be suppressed to less than 2× the eventual steady state level (e.g., ˜1.2× the eventual steady state level, in one example).

In addition to temporally staging the pump emitters, it is also possible to adjust the relative intensity of the pump emitters to each other. This may provide a further reduction of the gain switch spike to levels not greater than the final steady state value (e.g., to ˜0.5× the steady state level when reducing the pump intensity of pump 1 to ˜80% that of pumps 2 and pump 3). Some applications may benefit from a gain switch spike that is not greater than the final steady state value because this may relax power rating requirements for internal components of the laser and/or external components of an application setup.

In various embodiments, temporal staging and/or pump intensity reduction may be used in laser systems with two or more pumps to suppress the gain switch spike. In some embodiments, pump intensity reduction may be used in laser systems with one or more pumps to suppress the gain switch spike.

In one embodiment, to accomplish a temporal manipulation of the pump energy, the laser system may transmit a delay value to one or more pump modules. When the system-wide hardware gate turns on, each individual pump module may delay its diode driver gate by the specified amount of time with a predefined resolution (e.g., 16 ns). The pump emitters can then sequence the laser output—perhaps dynamically—to obtain a desired result at any power level, temperature, or preferred beam characteristic. The settings could be determined with a one-time characterization for all lasers or could be part of a calibration process for individual lasers. In one embodiment, “pump 1” may be initially turned on followed by “pump 2” (e.g., ˜2 μs after pump 1) followed by “pump 3” (e.g., ˜4 μs after “pump 1”).

Some applications may have a rise time requirement for a given output laser beam—for example a rise time requirement for a threshold power output to be reached within a maximum total time, e.g., within 10 μs. A user interface in such a system may constrain delay value settings based on the rise time requirement. For example, a delay increment of ˜2 μs may be acceptable/selectable in a system with three pump modules, but not in a system with ten pump modules. In such a system, a ˜1 μs delay may be an optimal maximum delay amount with a rise time requirement of no more than 10 μs.

In one embodiment, to accomplish both temporal and amplitude manipulation, the pumps may be turned on in sequence as above with at least one of the pumps at a different intensity than at least another one of the pumps. For example, the following relative pump intensities of pumps 1-3 may be 80%, 100%, and 100%, respectively (with 100% being a maximum pump intensity of the corresponding pump emitter).

Some applications may have a final output power requirement of an output laser beam for a given application—for example, an application may require an output laser beam of 10 kW. As user interface in such a system may constrain intensity ratios/percentages based on the final output power requirement. For example, in an example system with two pump modules capable of producing 6 kW final output power when both operated at full intensity and a final power output requirement of 5 kW, a user interface in such a system may constrain a user selection of a reduced pump intensity value to a minimum of 70% to meet the final output power requirement (e.g., pump 1 may be 70% (or greater) and pump 2 may be 100%). Also, in embodiments with more than two pump modules, there may be more than one reduced pump intensity ratio/percentage (such as 80%, 90%, and 100% in an example with three pump modules), or some other combination in which intensity reduced is inversely proportional to delay amounts.

In other laser systems, where only a single pump emitter is used, gain spike suppression may be provided by slowing down the ramp at which pump energy is supplied to the gain medium. In the case of a single pump emitter, this might be accomplished by slowing down the current ramp from the laser diode driver either through hardware, firmware, or software control.

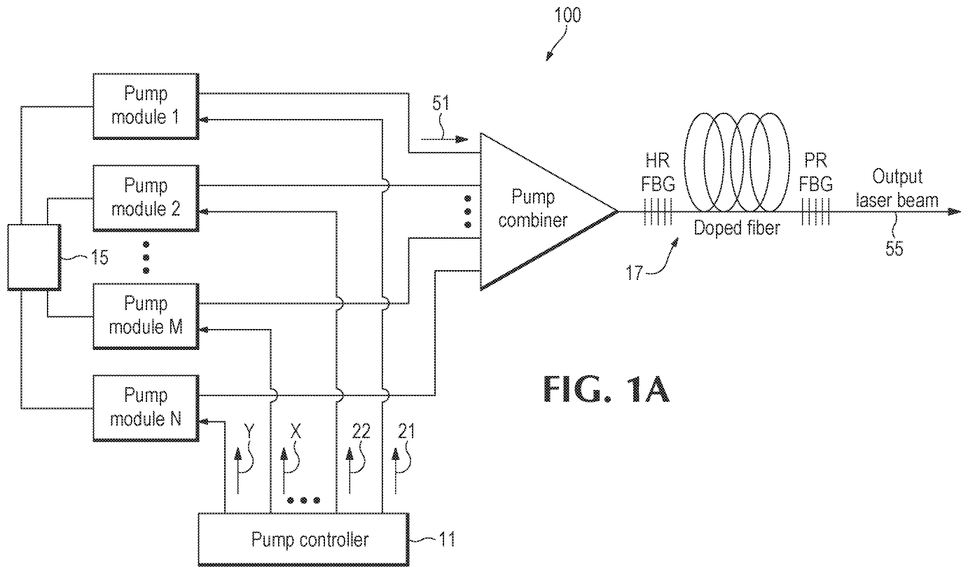

FIGS. 1A and 1B illustrate schematic diagrams of a laser system 100 arranged for gain switch spike suppression, according to various embodiments. The laser system 100 includes a gain medium 17, which includes at least one fiber core of at least one fiber in this example. In other embodiments, gain spike suppression may be used in any type of laser system (e.g., not limited to fiber laser systems). In other examples, the gain medium may be any material, now known or later developed, that exhibits optical gain, and generates a laser output beam 55 (which may be a continuous wave beam or a pulsed laser beam) when a laser threshold of the gain medium is reached.

A plurality of pumps modules 1-N (e.g., a homogenous group of pump emitters), powered by a power source 15, are arranged as a pump source of the laser system 100, e.g., to provide energy to the gain medium 17 to increase the energy state of that medium 17. Each of the pump modules 1-N may include an individual driver (not shown) to act on an individual pump emitter (not shown). The controller 11 may communicate with the drivers of the pump modules 1-N. In other examples, pump modules 1-N may include individual pump emitters and circuitry to accept commands from the controller 11.

The controller 11 may be implemented using any type of circuitry. In some embodiments, the circuitry may include a memory storing instructions that, when executed by a processor, perform any of the functions described herein. In other embodiments, the circuitry may be logic or some other application specific hardware.

The controller 11 may send configurations 21-Y to the pump modules 1-N, respectively. Each configuration 21-Y may include a delay value and/or a pump intensity value for a corresponding one of the pump modules 1-N. In this example, the configuration 21 specifies no delay (e.g., a delay value of zero) and no intensity reduction (e.g., 100% intensity). The pump module 1, as a result, generates an output 52 at full intensity.

Referring now to FIG. 1B, the pump module 2 initiates the output 52 at a delay relative to the initiation of the output 51 (because the configuration 22 (FIG. 1A) for pump module 2 specifies a delay relative to the configuration 21). In this example, the configuration 22 specifies no intensity reduction. The remaining ones of the configurations 21-Y may include progressively larger delay values relative to the configuration 21, to initiate outputs (not shown) at later times.

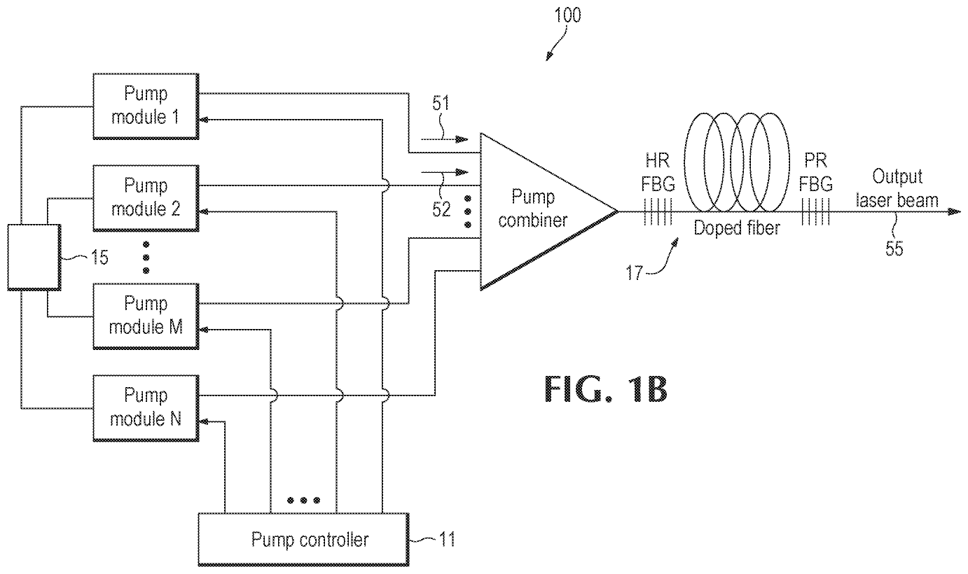

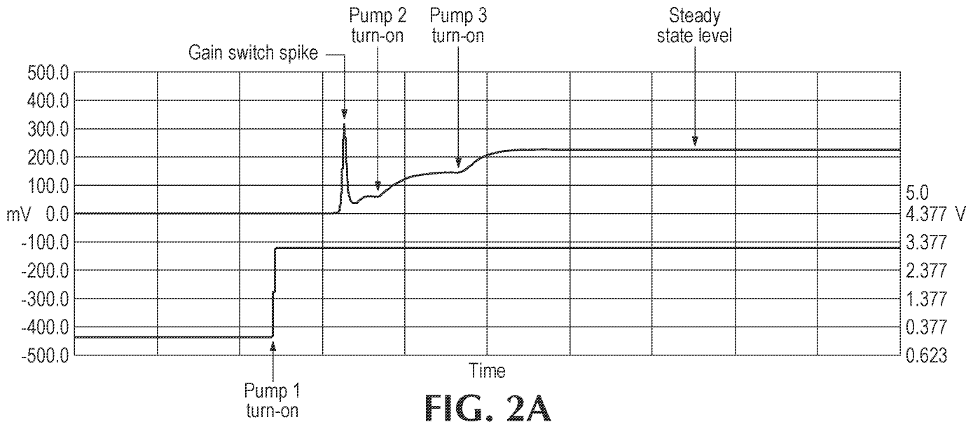

FIG. 2A illustrates an oscilloscope trace showing an improved gain switch spike corresponding to temporally delayed turn-ons of pump modules of a three-pump laser system similar in any respect to the laser system 100 of FIGS. 1A and 1B. The trace shows the delayed turn-on of output 52 (FIG. 1B), as well as the further delayed turn-on of a third pump module. In this example, the magnitude of the gain switch spike is 310 mV, which is about 1.3× the steady state magnitude of 233.3 mV.

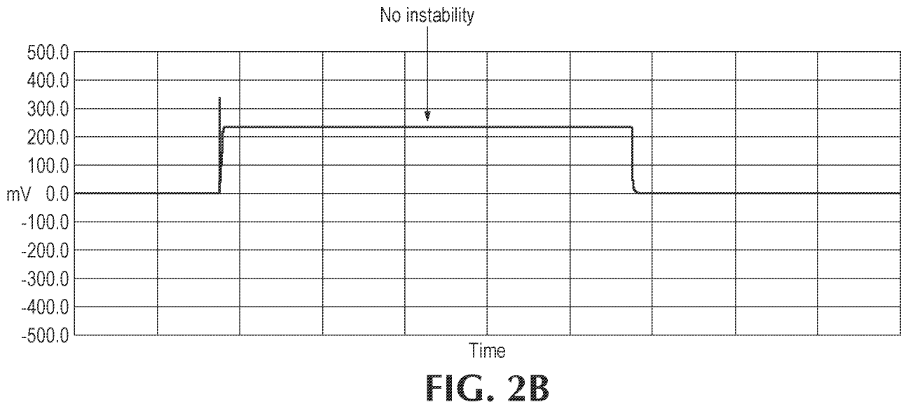

FIG. 3 illustrates an optical spectrum analyzer time averaged trace plotting reduced SRS generated non-linear light when using the temporally delayed turn-ons of pumps of the three-pump laser system with the operational characteristics shown in FIG. 2A.

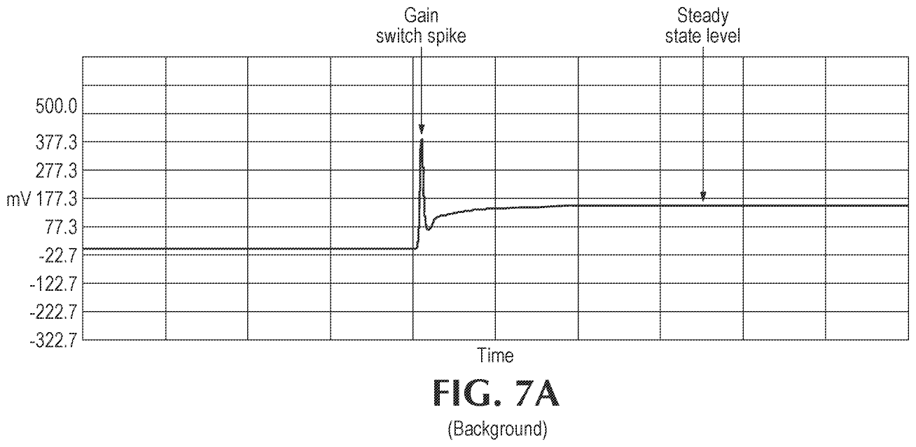

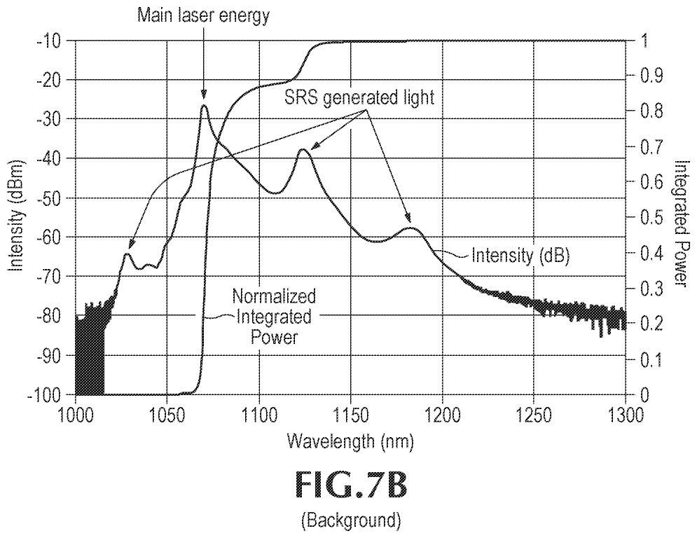

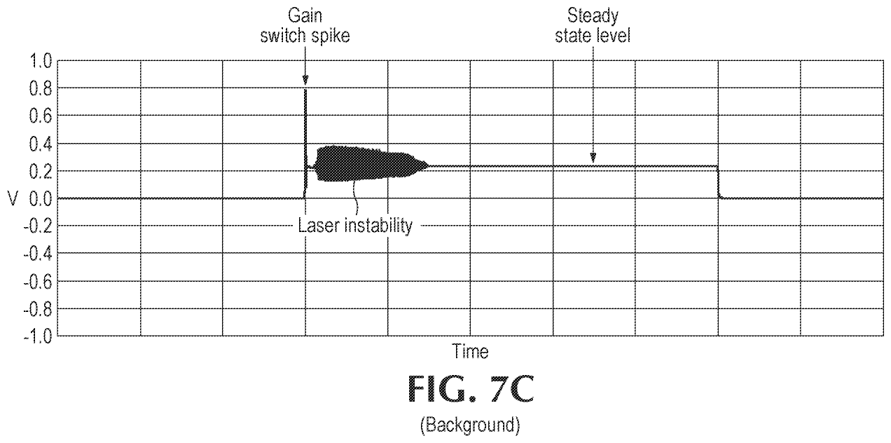

As would be understood by those skills in the art for known laser systems, the peak power of an unsuppressed gain switch spike (FIG. 7A) can drive non-linear laser processes such as Stimulated Raman Scattering (SRS) where the time averaged optical spectrum contains much greater quantities of SRS light (FIG. 7B). SRS is a non-linear process where energy from the main laser signal wavelength is transferred to other wavelengths. Again, this situation could create reliability risks to both internal and external components of an application setup. In addition to the reliability risks, the different wavelengths of light might interact with any optical setup differently than intended (for example, this light might focus differently than the main signal light) and create unintended results. In various embodiments, light generated outside of the 1050-1100 nm band may be reduced by more than 50%.

FIG. 7C illustrates an oscilloscope trace showing laser instability after generation of the gain switch spike produced in a three pump module laser system in which all three pumps are turned on at the same time with the same intensity. The illustrated laser instability is initiated due to high levels of SRS light which are generated due to a high peak power of the gain switch spike.

Laser instability may also be improved in the three-pump laser system, the improvement being made apparent when the optical spectrum of FIG. 3 (a disclosed embodiment) is compared to the optical spectrum of FIG. 7B (known). FIG. 7C illustrates laser instability caused the SRS generated light illustrated in FIG. 7B.

As the figures highlight, the amount of generated SRS light has been significantly reduced in FIG. 3, compared to FIG. 7B, due to the reduction in the peak amplitude of the gain switch spike. Moreover, as shown in FIG. 2B, the laser instability of FIG. 7C is not initiated when the reduced SRS is generated, as shown in FIG. 3. Also, the SRS generated light described in FIG. 3 has fewer peaks than the SRS generated light described in FIG. 7B. Specifically, the SRS generated light in FIG. 7B includes three additional peaks besides the main laser energy peak—specifically a first anti-Stoke peak prior to the main laser energy peak, and a first and second Stokes peaks following the main laser energy peak. In contrast, the SRS generated light in FIG. 3 has fewer additional peaks besides the main laser energy peak. Referring to FIG. 3, the optical spectrum does not include the anti-Stokes peak or the second Stokes peak.

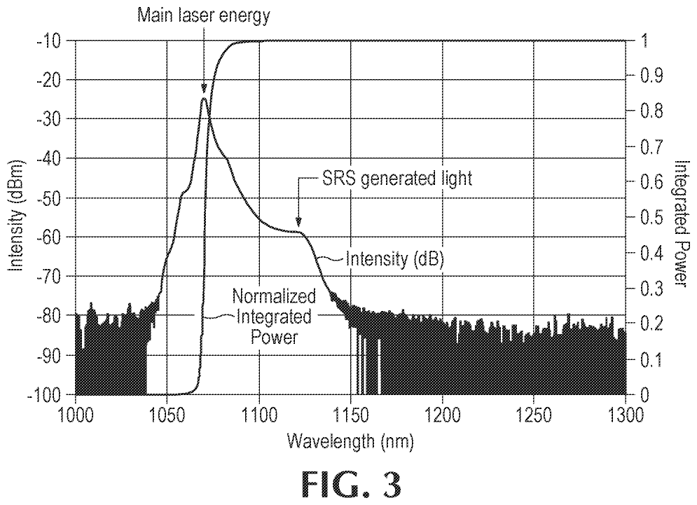

FIG. 4 illustrates another oscilloscope trace showing another improved gain switch spike corresponding to temporally delayed activations of pump emitters in combination with amplitude manipulation. In this embodiment, the magnitude of the gain switch spike is less than the steady state magnitude (e.g., about half the final steady-state value). This is achieved by reducing the intensity of pump module 1 to about 80% of the intensity of pump modules 2 and 3 (in addition to the same temporal delays described with respect to FIG. 2A).

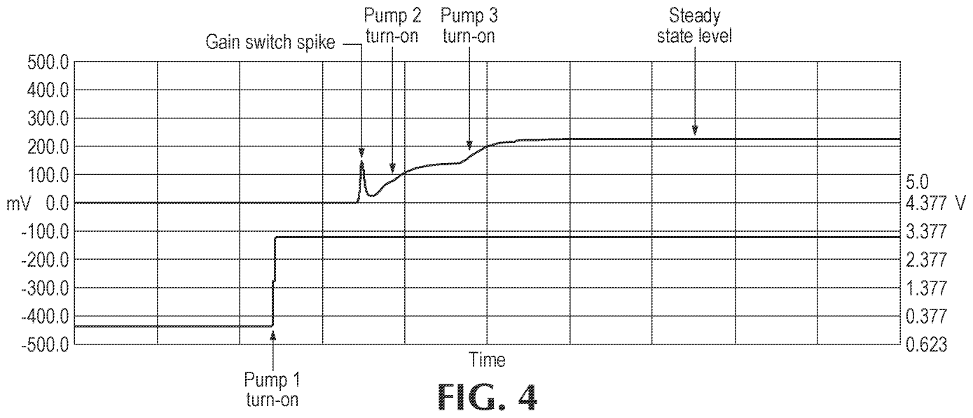

FIG. 5 illustrates a schematic diagram of a laser system 500 arranged for gain switch spike suppression in which amplitude manipulation is used with a single pump emitter, according to various embodiments. The laser system 500 includes a gain medium 517 (which may be similar to any gain medium described herein) to generate an output laser beam 555. The laser system 500 includes a single pump emitter, powered by a power source 515, and a pump controller 511 to generate a configuration 522 for the single pump emitter.

In this example, the configuration 522 may include one or more intensity values. For example, the configuration 522 may specify a first intensity for a first period of time, and a second, different intensity for a second period of time that is after the first period of time, e.g., 80% intensity in the first time period and 100% intensity in the second time period, as one example. The beginning of the second time period may be specified using a delay value, but this is not required. In other examples, the configuration 522 may cause the module to turn-on at a reduced intensity and a rate for gradually increasing the intensity to a greater intensity (e.g., full intensity or some other selected intensity).

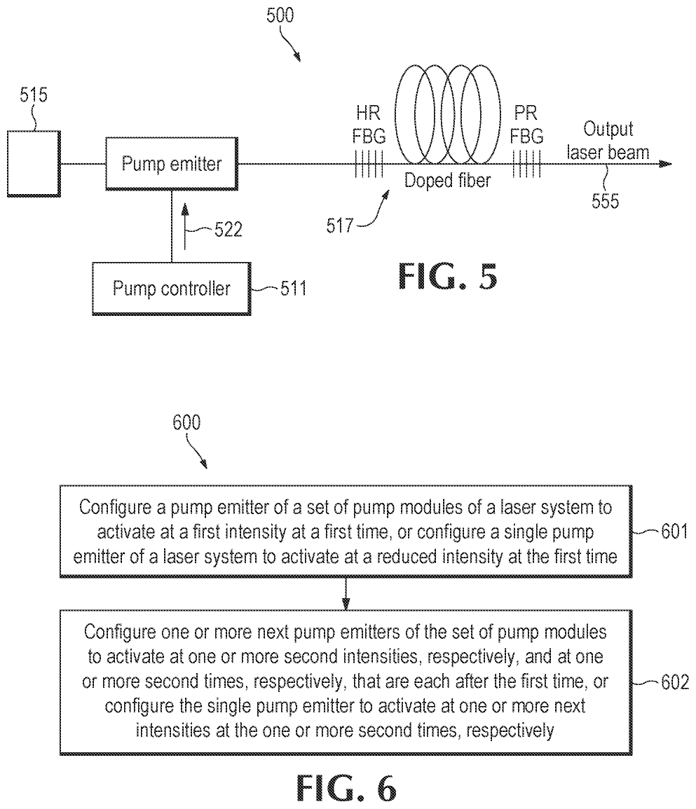

FIG. 6 is a flowchart illustrating operations 600 performed by a pump controller (e.g., pump controller 11 or 511) arranged for gain switch spike suppression through temporal and/or amplitude manipulation of the pump energy, according to various embodiments. The controller may be implemented using circuitry such as one or more processors (e.g., one or more general purpose processors to execute instructions stored in a memory, or the controller may be implemented as an application-specific integrated circuit).

In block 601, the controller may configure a pump emitter of a set of pump modules of a laser system to activate at a first intensity at a first time. In a single pump emitter system, the controller may configure the pump emitter of a laser system to activate at a reduced intensity at the first time. This may energize a gain medium to less than a laser threshold.

In block 602, the controller may configure one or more next pump emitters of the set of pump modules to activate at one or more second intensities, respectively, and at one or more second times, respectively, that are each after the first time. In the single pump emitter system, the controller may configure the pump emitter to activate at one or more next intensities at the one or more second times, respectively.

The configurations by the controller may cause the gain medium to reach the laser threshold. The generated laser beam may have a gain switch spike that is less than some other laser systems, and may have less instability than some other laser systems. In one embodiment using a fiber laser, the improved gain switch spike and/or the improved stability may allow a longer feeding fiber, a longer delivery fiber, and/or a longer process fiber than possible with some other fiber laser systems, which may enable various new applications. In another embodiment, the reduced gain switch spike and/or the improved stability may allow for a laser beam of higher beam quality, which may also enable various new applications.

Any gain switch spike suppression techniques described herein (e.g., through temporal and/or amplitude modulation of the pump energy) may be utilized in laser systems arranged to output continuous wave laser or pulsed output lasers.

In various embodiments, the system 100 (FIG. 1) may display a user interface capable of setting the delay values and the intensity ratios/percentages described herein. This user interface may implement any of the user interface features described herein. In some examples, the user interface may be a basic input/output system (BIOS) or some other operating system module. If the pump controller 11 is implemented using one or more processors, the user interface may be operated/controlled by a processor of these one or more processors. In other embodiments in which the pump controller 11 is implemented using application specific hardware, then different hardware of the system 100 (e.g., a programmed general purpose processor) may control/operate the user interface.

Some of the equipment discussed above comprises hardware and associated software. For example, the typical pump controller is likely to include one or more processors and software executable on those processors to carry out the operations described. The term software is used herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. This is not intended to convey or to imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

In view of the many possible embodiments to which the principles of the disclosed technology may be applied, it should be recognized that the illustrated embodiments are only preferred examples and should not be taken as limiting the scope of the disclosure. We claim as our invention all that comes within the scope and spirit of the appended claims.

What is claimed is:

1. An apparatus to operate with a laser system that includes a gain medium and at least one pump emitter to energize the gain medium, the apparatus comprising:
circuitry to operate the at least one pump emitter to energize the gain medium, the circuitry to:
configure the at least one pump emitter to activate at a first intensity at a first time; and
configure the at least one pump emitter to activate at one or more second intensities at one or more second times, respectively;
wherein an intensity of the one or more second intensities is greater than the first intensity, or
wherein:
the at least one pump emitter comprises a plurality of pump emitters,
the circuitry to configure a first pump emitter of the plurality of pump emitters to activate at the first intensity at the first time, and
the circuitry to configure one or more second pump emitters of the plurality of pump emitters to activate at the one or more second times, respectively.

2. The laser system of claim 1, wherein at least one second intensity of the one or more second intensities comprises a maximum intensity of the corresponding pump emitter.

3. The laser system of claim 1, wherein the pump emitters of the plurality of pump modules each have a same maximum intensity.

4. The laser system of claim 3, wherein the pump emitters of the plurality of pump modules comprise a homogenous group of pump emitters.

5. The laser system of claim 1, the circuity to:
delay activation of a pump emitter of the one or more second pump emitters by an amount of time relative to the activation of the first pump emitter; and
delay activation of a next pump emitter of the one or more second pump emitters by a greater amount of time relative to the activation of the first pump emitter.

6. The laser system of claim 5, the circuitry to delay activation of the next pump emitter relative to the activation of the second pump emitter, by said amount of time.

7. The laser system of claim 1, wherein further comprising at least one fiber, wherein the gain medium comprises a at least one fiber core of the at least one fiber.

8. The laser system of claim 1, wherein each pump emitter comprises a set of laser diodes.

9. The laser system of claim 1, wherein the laser system is arranged to output a continuous wave beam or pulsed beam when a laser threshold of the gain medium is reached.

10. The laser system of claim 9, wherein a magnitude of a gain switch spike of the laser system is not greater than a magnitude of a steady state level of the continuous wave beam or the pulsed beam.

11. A method of operating a laser system that includes a gain medium and at least one pump emitter to energize the gain medium, the method comprising:
configuring the at least one pump emitter to:
activate at a first intensity at a first time; and
activate at one or more second intensities at one or more second times, respectively; and
outputting a laser beam from the laser system, the laser beam generated by the gain medium pumped by the configured at least one pump emitter;
wherein an intensity of the one or more second intensities is greater than the first intensity, or
wherein the at least one pump emitter comprises a plurality of pump emitters; and the method further comprises configuring a first pump emitter of the plurality of pump emitters to activate at the first intensity at the first time, and configuring one or more second pump emitters of the plurality of pump emitters to activate at the one or more second times, respectively.

12. The method of claim 11, wherein at least one second intensity of the one or more second intensities comprises a maximum intensity of the corresponding pump emitter.

13. The method of claim 11, wherein the pump emitters of the plurality of pump modules each have a same maximum intensity.

14. The method of claim 13, wherein the pump emitters of the plurality of pump modules comprise a homogenous group of pump emitters.

15. The method of claim 11, further comprising:
delaying activation of a pump emitter of the one or more second pump emitters by an amount of time relative to the activation of the first pump emitter; and
delaying activation of a next pump emitter of the one or more second pump emitters by a greater amount of time relative to the activation of the first pump emitter.

16. The method of claim 15, further comprising delaying activation of the third pump emitter relative to the activation of the second pump emitter, by said amount of time.

17. The method of claim 11, wherein the laser system includes at least one fiber, wherein the gain medium comprises at least one fiber core of the at least one fiber.

18. The method of claim 11, wherein each pump emitter comprises a set of laser diodes.

19. The method of claim 18, wherein a steady state level of the laser beam has a magnitude that is greater than a magnitude of a gain switch spike of the laser system.

20. The method of claim 11, further comprising configuring the one or more second pump emitters of the plurality of pump emitters to activate at one or more second intensities, respectively, at the one or more second times, respectively;
wherein one or more second intensities are greater than the first intensity.
